(19) United States
(12) Patent Application Publication
(10) Pub. No.: US 2006/0002428 A1
(43) Pub. Date: Jan. 5, 2006

(54) System, method and device for wireless transmission

(76) Inventor: Solomon B. Trainin, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/879,481

(22) Filed: Jun. 30, 2004

(51) Int. Cl. H04J 3/06

(52) U.S. Cl. 370/503

(57) ABSTRACT

Embodiments of the present invention provide a method, apparatus and system for wireless transmission. The method according to some exemplary embodiments of the invention may include performing during a first time period of a burst mode at least one transmission-related operation corresponding either to a previous data frame or to transmission of a current data frame during a second time period of the burst mode, wherein the first time period at least partially overlaps the second time period. Additionally or alternatively, the method may include. Other embodiments are described and claimed.

### BACKGROUND OF THE INVENTION

Bursting is a method of sending wireless communication or wireless data frames, such as those used in the IEEE 802.11(e) standard, in succession without a backoff period between frames. In order for a wireless data frame to be included in an ongoing burst, the frame must be transmitted within the Short Inter Frame Space (SIFS) or Point Inter Frame Space (PIFS) of the frame that preceded it or the ACK of the frame that preceded it. The latency or late arrival of data from a host such as for example a personal computer (PC), hand-held device or other computing device to a wireless device such as for example a network interface card (NIC) may require that a central processing unit (CPU) of the wireless device perform a large number of operations in a very short period before the expiration of the burst. This may impose undue speed requirements on a CPU of a wireless device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic diagram of a wireless communication system in accordance with some exemplary embodiments of the present invention;

FIG. 2 is a schematic illustration of a communication station in accordance with some exemplary embodiments of the invention;

FIG. 3 is a schematic illustration of a transmit command in accordance with some exemplary embodiments of the invention;

FIG. 4 is a schematic illustration of a sequence of operations performed by the station of FIG. 2 in accordance with some exemplary embodiments of the invention; and

FIGS. 5A-5C are schematic flow-chart illustrations of a method of transmitting data frames, in accordance with some exemplary embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that the present invention may be used in a variety of applications. Although the present invention is not limited in this respect, the circuits and techniques disclosed herein may be used in many apparatuses such as units of a wireless communication system, for example, a Wireless Local Area Network (WLAN) communication system and/or in any other unit and/or device. Units of a WLAN communication system intended to be included within the scope of the present invention include, by way of example only, modems, Mobile Units (MU), Access Points (AP), wireless transmitters/receivers, and the like.

Types of WLAN communication systems intended to be within the scope of the present invention include, although are not limited to, WLAN communication systems as described by “IEEE-Std 802.11, 1999 Edition (ISO/IEC 8802-11: 1999)” standard (“the 802.11 standard”), and more particularly in “IEEE-Std 802.11e-2002 Supplement to 802.11-1999, Wireless LAN MAC and PHY specifications: Medium Access Control (MAC) Quality of Service (QoS) Enhancements” (“the 802.11e standard”), and the like.

Although the scope of the present invention is not limited in this respect, the circuits and techniques disclosed herein may also be used in units of wireless communication systems, digital communication systems, satellite communication systems and the like.

Devices, systems and methods incorporating aspects of embodiments of the invention are also suitable for computer communication network applications, for example, intranet and Internet applications. Embodiments of the invention may be implemented in conjunction with hardware and/or software adapted to interact with a computer communication network, for example, a LAN, wide area network (WAN), or a global communication network, for example, the Internet.

Part of the discussion herein may relate, for exemplary purposes, to transmitting a packet over a channel. However, embodiments of the invention are not limited in this regard, and may include, for example, transmitting a signal, a block, a data portion, a data sequence, a frame, a data signal, a preamble, a signal field, a content, an item, a message, a protection frame, or the like.

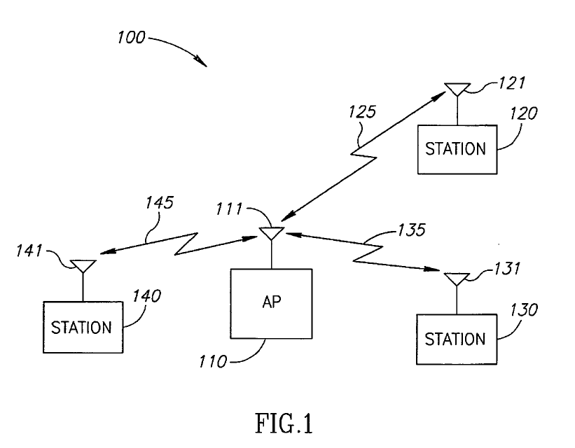

Reference is made to FIG. 1, which schematically illustrates a wireless communication system 100 in accordance with an embodiment of the present invention.

In some exemplary embodiments of the invention, communication system 100 may include a WLAN system. Although the scope of the present invention is not limited in this respect, communication system 100 may be defined, by the 802.11 standard, as a Basic Service Set (BSS). For example, the BSS may include at least one communication station, for example, an AP 110, and stations 120, 130, and 140 at least one of which may be a MU. In some embodiments, stations 140, 130 and 120 may transmit and/or receive one or more packets over wireless communication system 100. The packets may include data, control messages, network information, and the like. Additionally or alternatively, in other embodiments of the present invention, wireless communication system 100 may include two or more APs and two or more mobile stations, in which case wireless communication system 100 may be referred to as an extended service set (ESS), as defined by the 802.11 standard, although the scope of the present invention is not limited in this respect.

According to exemplary embodiments of the invention, AP 110 may include one or more antennas 111 for transmitting and/or receiving packets, e.g., to/from stations 120, 130 and/or 140. Stations 120, 130 and/or 140 may include one or more antennas 121, 131 and/or 141, respectively, for transmitting and/or receiving packets, e.g., to/from AP 110. Although the scope of the present invention is not limited in this respect, types of antennae that may be used for antennas 111, 121, 131, and/or 141 may include but are not limited to internal antenna, dipole antenna, omni-directional antenna, a monopole antenna, an end fed antenna, a circularly polarized antenna, a micro-strip antenna, a diversity antenna and the like.

According to exemplary embodiments of the invention, AP 110 may include suitable WLAN AP communication circuitry, for example, AP circuitry able to operate in accordance with the 802.11 standard and/or any other suitable standard. For example, AP 110 may be able to control communication between AP 110 and stations 120, 130 and/or 140 by sending management commands, e.g., via beacons 125, 135, 145, if desired. For example, AP 110 may implement a Carrier Sense, Multiple Access/Collision Avoidance (CSMA/CA) mechanism, which may include a Request-To-Send/Clear-To-Send (RTS/CTS) mechanism, which may be used to provide collision protection to the transmission of a data frame, if desired.

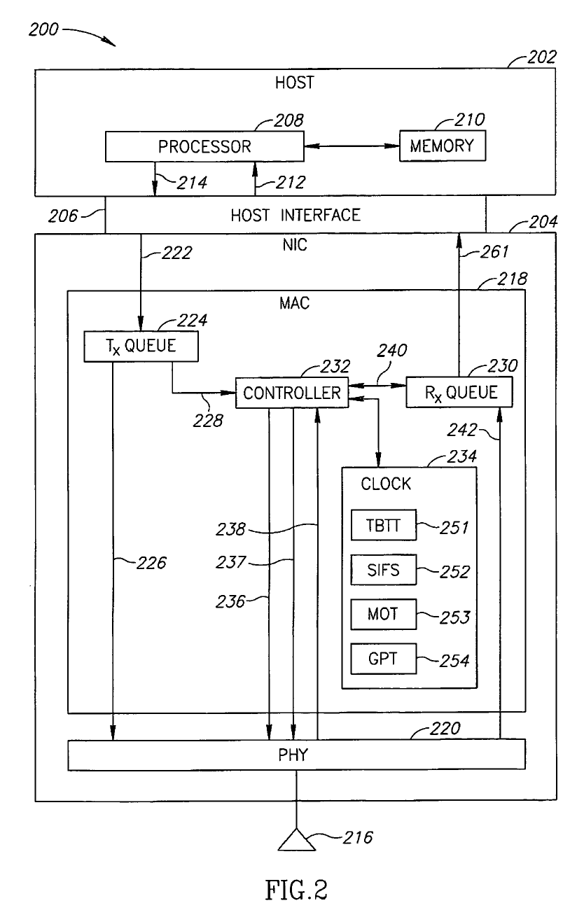

Reference is made to FIG. 2, which schematically illustrates a station 200 in accordance with some exemplary embodiments of the invention. Although the invention is not limited in this respect, station 200 may be used to perform the functionality of at least one of stations 120, 130 and 140 (FIG. 1).

According to exemplary embodiments of the invention, station 200 may include a host 202 associated with a wireless communication module, e.g., a Network Interface Card (NIC) 204, for example, via a host interface 206, as are described in detail below.

In some embodiments, host 202 may include or may be, for example, a computing platform, e.g., a personal computer, a desktop computer, a mobile computer, a laptop computer, a notebook computer, a terminal, a workstation, a server computer, a Personal Digital Assistant (PDA) device, a tablet computer, a network device, or other suitable computing device.

According to some exemplary embodiments of the invention, host 202 may include a processor 208, which may be associated with a memory 210. Processor 208 may include, for example, a Central Processing Unit (CPU), a Digital Signal Processor (DSP), a microprocessor, a host processor, a plurality of processors, a controller, a chip, a microchip, or any other suitable multi-purpose or specific processor or controller. Processor 208 may be able to produce signals 214 including blocks intended for transmission via at least one antenna 216, e.g., as described below. For example, processor 208 may be able to provide host interface 206 with signals 214 including at least one transmission (Tx) command block, e.g., as described below. Host interface 206 may include any suitable hardware and/or circuitry, e.g., as known in the art, for receiving signals 214 and for producing signals 222 including the blocks of signals 214 in a format suitable for NIC 204.

According to exemplary embodiments of the invention, NIC 204 may include a Media Access Control (MAC) module 218 associated with host interface 206, and a Physical (PHY) layer 220 associated with MAC 218 and antenna 216, as are described in detail below.

According to exemplary embodiments of the invention, MAC 218 may include a Tx queue module 224, a Receive (Rx) queue module 230, a controller 232 and a clocking module 234, as are described below. For example, Tx queue module 224 may include a Tx First In First Out (FIFO) module and/or Rx queue module 230 may include a Rx FIFO module, as are known in the art. Tx module 224 may be able to produce signals 226 including a data portion of the blocks of signals 222, and/or signals 228 including a Tx sub-command portion of the of blocks of signals 222, e.g., as are described below. Clocking module 234 may include a Target Beacon Transmission Time (TBTT) clocking module 251, a Short Inter Frame Space (SIFS) timer 252, a Media Occupancy Timer (MOT) 253 to time a Tx opportunity (TxOp) for a frame, and a General Purpose Timer (GPT) 254, e.g., as are known in the art.

According to some exemplary embodiments of the invention, controller 232 may receive signals 228 and produce control signals 236 and/or data signals 237, as described in detail below. Although the present invention is not limited in this respect, controller 232 may include, for example, an embedded processor, e.g., a CPU, a microprocessor, a plurality of processors, a chip, a microchip, or any other suitable multi-purpose or specific processor able to produce signals 236 and/or 237 according to a predetermined algorithm, e.g., as described below. PHY 220 may include any suitable circuitry and/or hardware, for example, able to modulate signals 226 and/or one or protection data, e.g., RTS data of signals 237, and transmit the modulated signals and/or other signals, e.g., preamble signals, via antenna 216, in accordance with control signals 236. PHY 220 may also include suitable circuitry and/or hardware for demodulating one or more signals, e.g., including one or more data signals, received via antenna 216 and for producing data signals 242, e.g., as is known in the art. PHY 220 may also be adapted to produce control signals 238, e.g., corresponding to a transmit event such as, for example, the event of receiving one or more signals, ending the transmission of one or more signals, as known in the art.

According to exemplary embodiments of the invention, controller 232 may be able to control Rx module 230, e.g., using signals 240, as described below. Rx module 230 may be able to receive signals 242 and/or 240 and to produce signals 261, e.g., according to a FIFO sequence, as is known in the art. Host interface 206 may be able to provide processor 208 with signals 212 including signals 261 in a format suitable for processing by processor 208, as known in the art.

In some embodiments and in accordance with some protocols or standards such as, for example, the 802.11 e standard, controller 232 may control PHY 220, e.g., using control signals 236, to transmit wireless data frames, e.g., including data of signals 226, in a succession or burst, e.g., where no back-off period is required between the transmitted frames. In a burst mode two or more wireless data frames may be transmitted and may be separated one from another by only SIFS or Point Inter Frame Space (PIFS). In some embodiments an ACK signal may also be transmitted between one or more of the data frames.

According to some exemplary embodiments of the invention, it may be desirable to wait until the last possible moment for one or more data blocks to arrive from host 202 to NIC 204 such that at least some of the data blocks may be included in a transmission corresponding to a burst mode, e.g., as described below. However, waiting for the last possible moment to insert data into a frame and determine whether a frame may be included in a transmission corresponding to the burst mode may add to the number of tasks that must be performed by, for example, controller 232 at such last possible moment and hence to the speed requirements of controller 232.

According to some exemplary embodiments, changes in the order of the tasks that are performed by controller 232 in the course of preparing a frame for bursting may decrease the number of tasks that controller 232 may perform at the last possible moment before a frame is to be joined to a burst. Similarly, performing certain tasks that are included in the bursting processes during intervals when controller 232 is not otherwise heavily engaged in processing data may reduce the speed requirements of controller 232. Accordingly, it may be desirable to provide controller 232 with information indicative to whether the frame intended for transmission is suitable for bursting.

According to some exemplary embodiments of the invention, MAC 218 may be provided with a Tx command including one or more bits representing burst-related sub-commands and/or parameters related to a burst mode, e.g., as described below.

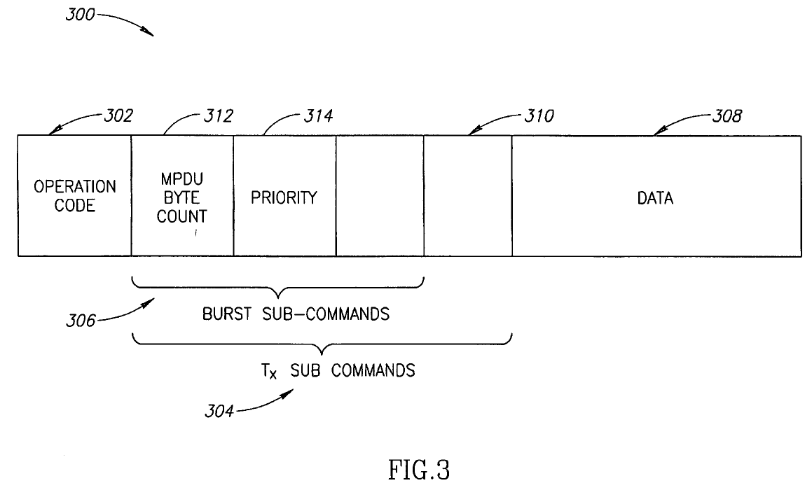

Reference is made to FIG. 3, which schematically illustrates a Tx command 300 according to some exemplary embodiments of the invention. Although the invention is not limited in this respect, processor 208 (FIG. 2) may be able to produce signal 214 (FIG. 2) including Tx command 300.

According to some exemplar embodiments of the invention, Tx command 300 may include a Tx sub-command portion 304 followed by a data portion 308. Optionally, Tx command 300 may also include an operation code portion 302, e.g., including one or more bits representing a Tx command identifier byte and/or a sequence number byte, as are known in the art.

According to exemplary embodiments of the invention, portion 304 may include one or more bits representing one or more burst-related sub-commands and/or parameters of the burst mode. In some embodiments, such bits may represent the Quality of Service (QOS) of the data to be transmitted, the priority of the data to be transmitted and/or the expected transmission time of the frame as may be determined, for example, by the number of bytes of the frame divided by the data rate. Bits representing other parameters and/or sub-commands corresponding to indications of the suitability of a frame for bursting may also be included. For example, portion 304 may include a MAC Protocol Data Units (MPDU) byte count sub-command 312, e.g., including two bytes having a value relating to the length of data portion 308. Portion 304 may also include a priority sub-command 314, e.g., succeeding sub-command 312 and including, for example, one byte having a value corresponding to the priority for transmitting data of portion 308 as is known in the art.

According to some exemplary embodiments of the invention, the bits representing the burst-related sub-commands of portion 304, e.g., sub-commands 312 and/or 314, may be preceded by no more than a non-significant number of bits representing other, e.g., non burst-related, sub-commands and/or parameters. For example, the bits representing the burst-related sub-commands of portion 304 may precede more than half, e.g., substantially all, of the bits representing other sub-commands of Tx command 300. For example, portion 304 may include a first portion 306 and a second portion 310. Sub-commands 312 and/or 314 may be, for example, represented by bits of portion 306, which may be located substantially at the beginning of portion 304. Portion 310 may succeed portion 306 and may include one or more bits representing the other Tx sub-command, e.g., a Tx flags sub-command, a Tx flags extension sub-command, a Key ID sub-command, a security key sub-command, a rate sub-command, a power extension sub-command, CW sub-commands, and/or any other Tx sub-commands and/or parameters, as are known in the art. Portion 308 may include a series of data bytes, e.g., between 14 and 2342 data bytes as known in the art.

Referring back to FIG. 2, the period during which PHY 220 may transmit a preamble signal, e.g., corresponding to a frame to be transmitted, may be relatively long and may be a period of relative inactivity for controller 232.

According to some exemplary embodiments of the invention, after PHY 202 begins to transmit the preamble of a certain frame, controller 232 may be able to perform a predetermined sequence of operations relating to the certain frame intended for transmission, e.g., including the data of signals 226 and/or the protection data of signals 237. For example, while PHY 202 transmits the preamble of a certain frame, controller 232 may be able to produce signal 240 including a response to host 202 as to whether a previously transmitted frame was successfully transmitted in a burst, prepare signal 240 corresponding to an ACK related to a previously transmitted frame, and/or to prepare the certain frame for transmission, i.e., to process one or more of the Tx sub-commands, e.g., of signals 228, corresponding to data signals 226 and/or to prepare protection data, e.g., RTS data, as described below.

According to exemplary embodiments of the invention, controller 232 may be able to evaluate the suitability of a certain frame for bursting even before the remainder of the data for such frame has been delivered from 202. For example, processor 208 may be able to provide NIC 204 bits representing one or more of the burst related sub-commands of a certain Tx command, e.g., one or more sub-commands of portion 306 (FIG. 3), before other portions of the certain Tx command, e.g., portions 310 and 308. Controller 232 may use one or more of the burst related sub-commands to determine whether the data to be delivered by host 202 will be suitable for inclusion in a frame that is to be part of a burst.

According to some exemplary embodiments, a burst may be sent during a pre-defined time known as a TxOp and the burst may be stopped at the expiration of the TBTT. The timing of the burst may in some embodiments be accomplished without intervention from host 202. In some embodiments, controller 232 may be able to prepare a frame in a burst as late as possible towards the expiration of the SIFS or PIFS, e.g., as timed by timer 234, so as to increase the likelihood of bursting in the event of latency of data that may arrive from host 202. In some embodiments the latest opportunity to include a frame in a burst will be at the SIFS expiration, e.g., after the end of the transmission of a current frame if no ACK signal is expected on such frame, or at the expiration of the SIFS after receiving an ACK signal from a current frame. According to some embodiments, a frame in a burst may also be transmitted after expiration of the PIFS time, e.g., if there is an ACK signal that is expected but not received. Thus, for example, controller 232 may be able to wait for a predetermined time period (“wait-for-next-frame time period”) before starting to prepare the frame for burst, wherein the wait-for-next-frame time period may be predetermined such that sum of the wait-for-next-frame time period and the time period for processing the frame is substantially equal to the SIFS or PIFS time period, e.g., as described below.

According to some exemplary embodiments of the invention, controller 232 may implement a last-flag or other marker or indicator to indicate that a last frame that was transmitted crossed the TBTT, e.g., as timed by TBTT timer 251, and that no further frames may be transmitted in the burst, e.g., as described below. For example, controller 232 may include a predetermined memory space able to have a first value, e.g., the value one if the marker is at an “on” state, or a second value, e.g., the value zero if the marker is at an “off” state.

According to some exemplary embodiments, controller 232 may be able to evaluate the amount of time remaining on the TBTT, e.g., before or during the processing a frame intended for transmission in a burst, to determine whether such frame will cross or overlap on the time remaining on the TBTT. If the expected time for successful transmission of the frame, e.g., including the time for receiving any possible ACK signal in respect of the frame, is longer than the time that is remaining on the TBTT, then the frame may still be sent in the burst but the last flag may be set to indicate that no further frames are to be sent in the burst. In the event that the last flag is set following a burst controller may not permit any retry attempts of the last frame in the burst.

According to some exemplary embodiments of the invention, controller 232 may be able to determine whether a next frame of a next Tx command, e.g., a Tx command succeeding a prior frame successfully transmitted in a burst, is suitable for inclusion in the burst, e.g., as described below. For example, controller 232 may be able to determine whether the next frame may be suitable for bursting after transmission of the prior frame, or, if an ACK signal related to the prior frame is to be received, after the ACK signal is received, as described below.

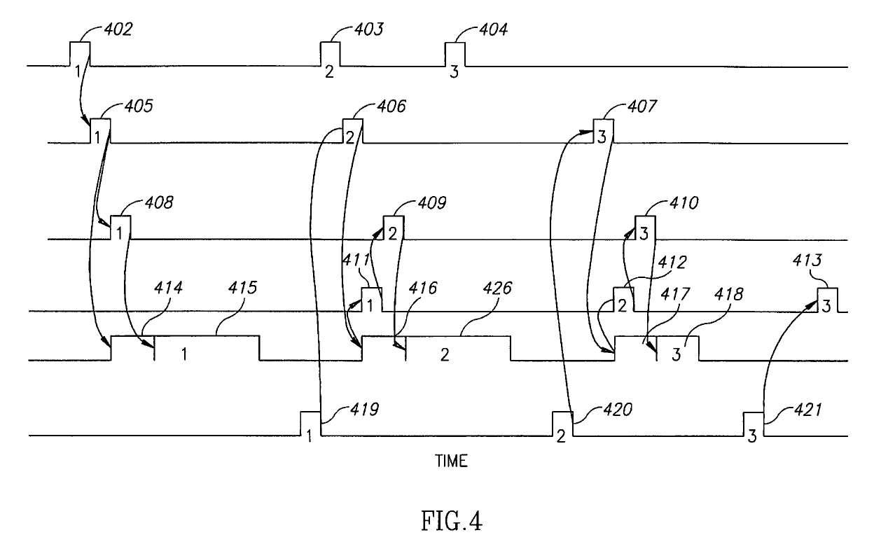

Reference is also made to FIG. 4, which schematically illustrates a sequence of operations performed by station 200 in accordance with some exemplary embodiments of the invention.

As illustrated in FIG. 4, host 202 may be able to produce signals 214 including a plurality of Tx commands, e.g., three Tx commands relating to three data frames during three time periods 402, 403 and 404, respectively.

According to some exemplary embodiments of the invention, controller 232 may be able to evaluate during a time period 405 whether the first data frame is suitable for bursting, whether the first data frame may be transmitted during the TBTT, and/or whether the TxOP is long enough for transmitting the first data frame in the burst, e.g., as described herein. If the first data frame is determined to be suitable for bursting, the transmission of the first data frame is determined to be during the TBTT, and/or the TxOP is determined to be long enough for transmitting the first data frame in the burst, then controller 232 may control PHY 220, e.g., using signals 236, to start transmitting the preamble of the first data frame or a preamble of a protection frame, e.g., related to the first data frame.

As illustrated in FIG. 4, controller 232 may be able to prepare and enable transmission of a first payload relating to the first data frame, e.g., according to one or more Tx sub-commands of signals 228, during a time period 408, e.g., within a time period 414 in which PHY 220 transmits the preamble of the first data frame. The payload may include, for example, the first data frame or a protection frame relating to the first data frame. PHY 220 may then transmit the first payload during a time period 415. An ACK signal in response to the first payload may be transmitted back to station 200, e.g., from AP 110 (FIG. 1), during a time period 419.

According to exemplary embodiments of the invention, controller 232 may be able, e.g., upon receiving the ACK signal corresponding to the first payload, to start evaluating whether the second data frame is suitable for bursting, whether the second data frame may be transmitted during the TBTT, and/or whether the TxOP is long enough for transmitting the second data frame in the burst, as described herein. If the second data frame is determined to be suitable for bursting, the transmission of the second data frame is determined to be during the TBTT, and/or the TxOP is determined to be long enough for transmitting the second data frame in the burst, then controller 232 may control PHY 220, e.g., using signals 236, to start transmitting the preamble of the second data frame or of a protection frame, e.g., related to the second data frame. PHY 220 may transmit the preamble during a time period 416.

As illustrated in FIG. 4, controller 232 may be able to provide a response to host 202, e.g., via signals 240, indicating the first data frame was successfully transmitted, e.g., during a time period 411. Controller 232 may then be able to prepare and enable transmission of a second payload relating to the second data frame, e.g., according to one or more Tx sub-commands of signals 228, during a time period 409, e.g., within a time period 416 in which PHY 220 transmits the preamble of the second data frame. The second payload may include, for example, the second data frame or a protection frame relating to the second data frame. PHY 220 may then transmit the second payload during a time period 426. An ACK signal in response to the second payload may be transmitted back to station 200 during a time period 420.

Accordingly, as illustrated in FIG. 4, controller 232 and PHY 220 may prepare and/or transmit the third data frame during time periods 407, 410, 412, 417 and 418. An ACK signal may be transmitted to station 200 during a time period 421, e.g., in analogy to the above description relating to the second frame. Upon receiving the ACK signal, controller 232 may be able to provide host 202 with a response indicative of the successful transmission of the third frame and/or of the ending of the burst transmission mode, since no additional frames are received from host 202 during the SIFS time, e.g., as described below.

According to some exemplary embodiments of the invention, controller 232 may include any suitable circuitry, hardware and/or software for performing at least some of the operations described above. For example, controller 232 may be able to execute a MicroCode (MC) corresponding to a suitable method for transmitting a data frame of a Tx command, e.g., as described below.

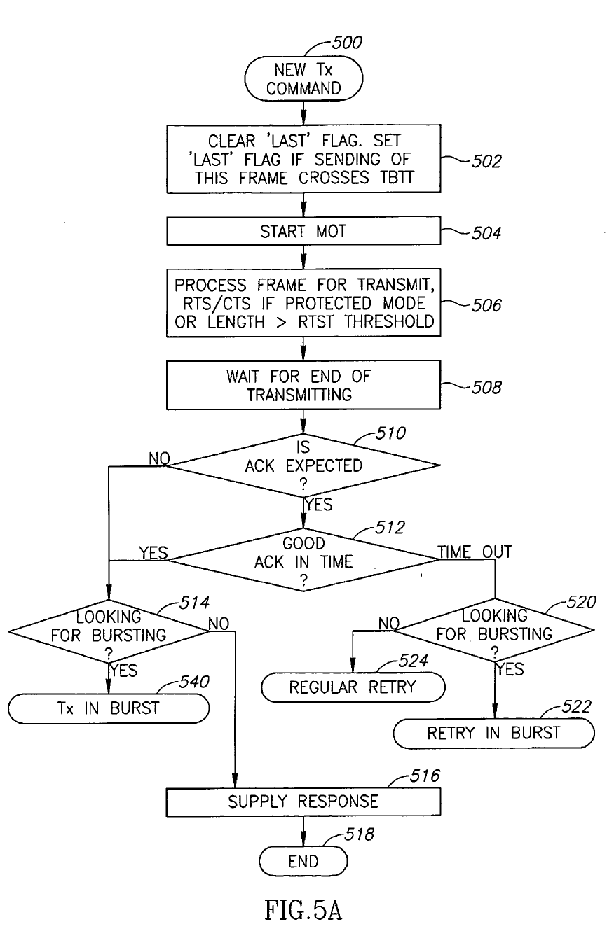

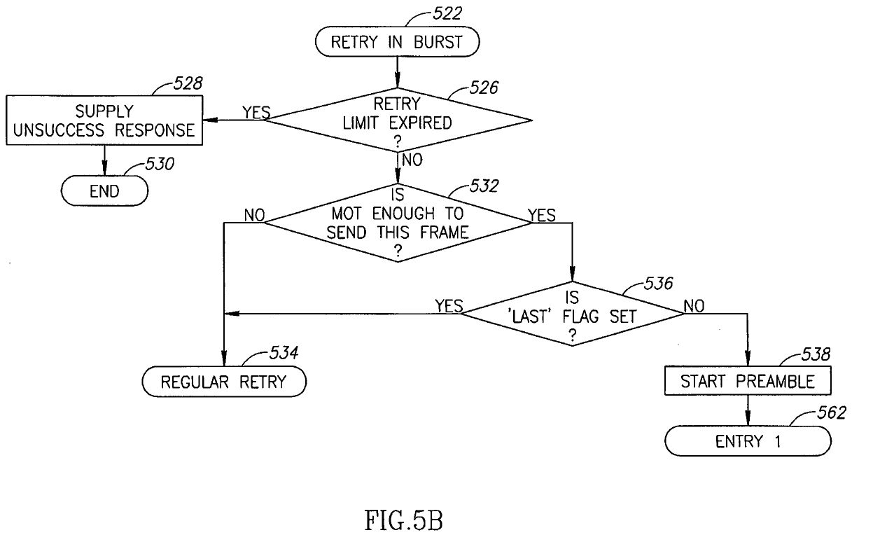

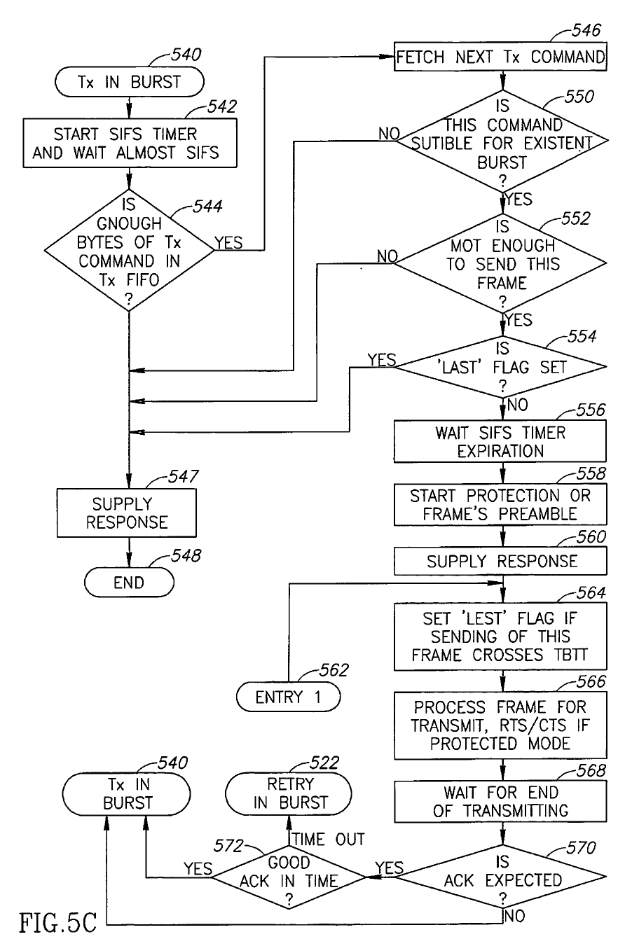

Reference is now made to FIGS. 5A-5C, which schematically illustrate a flow chart of a method of transmitting data frames, in accordance with some exemplary embodiments of the invention.

As indicated at block 500, the method may include receiving a first Tx command, for example, from host 202 (FIG. 2).

As indicated at block 502 the method may include clearing a last-flag, i.e., setting the flag to an “off” state, e.g., as described above. The method may also include evaluating an expected transmission time for transmitting a first frame, e.g., of the first Tx command, and comparing it with remaining time left in the TBTT, e.g., as timed by TBTT timer 251. If the expected transmission time is larger than the remaining time in the TBTT, then the last-flag may be set to the “on” state, e.g., indicating not to perform bursting of additional frames after the first frame.

As indicated at block 504, the method may include timing the TxOp. For example, MOT timer 252 may be activated to “count down” starting from the TxOp time.

As indicated at block 506, the method may include processing the first frame, e.g., in accordance with one or more Tx sub-commands of the first Tx command. Such processing may include, for example, preparing a Physical Layer Convergence Procedure (PLCP) header, preparing RTS and/or CTS protective frames, e.g., if the transmission is being made under such protection and/or if the first frame is longer than an RTS threshold length, and/or performing any other operations for transmitting the frame, e.g., as known in the art.

As indicated at block 508, the method may include transmitting the first frame.

As indicated at block 510, the method may include determining whether an ACK signal is expected on the transmitted frame, e.g., based on one or more sub-commands related to the Tx command. For example, a multicast frame may not require using an immediate ACK signal, certain QOS frames may also not require immediate ACKs.

As indicated at block 512, if an ACK signal is expected on the first frame, the method may include determining whether the ACK signal has been received within a predetermined time, e.g., as is known in the art.

As indicated at block 514, if no ACK is expected or if the ACK signal has been received within the predetermined time, then the method may include checking if the first frame is suitable for bursting, for example, by evaluating one or more burst-related sub-commands of the first Tx command and determining whether the first frame is suitable for bursting, e.g., in accordance with a predefined transmission protocol as known in the art.

As indicated at block 516, according to some exemplary embodiments of the invention, if the first frame is determined to not be suitable for bursting, then the method may include notifying the host of the successful transmission of the first frame. For example, controller 232 may produce signal 240 including a response having a value indicative of a successful transmission. The method may also include ending the transmission, as indicated at block 518.

As indicated at block 540, if the first frame is determined to be suitable for bursting, then the method may include transmitting a second frame, e.g., of a second Tx command succeeding the first Tx command, in a burst, e.g., as described below.

According to some exemplary embodiments, not receiving the ACK signal, e.g., during the predetermined time (“ACK time out”), may indicate that the transmitted frame was not successfully received or that the ACK of such frame was not successfully transmitted or received. As indicated at block 520, in case of such an ACK time-out, the method may include determining whether the first frame is suitable for bursting, e.g., using one or more of the burst-related sub-commands corresponding to such frame, as described above.

As indicated at block 522, if the transmitted frame is determined to be suitable for bursting, then the method may include attempting to retry in an existing burst the transmission of the first frame, e.g., as described below.

As indicated at block 524, if the first frame is determined not to be suitable for bursting, then the method may in some embodiments include attempting to retry a regular transmission of the first frame, e.g., as is known in the art. For example, the method may include waiting a requisite backoff period and treating the first Tx command as a TX command outside of a burst, e.g., as described above.

As indicated at block 526, the method may include determining whether a retry limit has expired for the first frame, e.g., as is known in the art. If the retry limit has expired, then the method may include informing the host that transmission of the first frame has been unsuccessful, as indicated at block 528. For example, controller 232 may produce signal 240 including a response value indicative of the unsuccessful transmission.

As indicated at block 532, if the retry limit has not expired, then the method may include determining whether there is enough time remaining in the TxOp, e.g., by checking MOT timer 252, to transmit the first frame within the burst.

As indicated at block 536, if it is determined that the time remaining in the TxOp is enough for transmitting the first frame during the burst, then the method may include checking if the last flag is set to the “on” state, e.g., indicating that a frame has been received from host 202 after the TBTT has expired.

As indicated at block 534, if it is determined that the time remaining in the Tx opportunity is not long enough for transmitting the first frame during the burst or if the last flag is set to the “on” state, then the method may include attempting to retry transmitting the first frame outside of the burst, e.g., using a regular retry attempt after waiting a backoff period.

As indicated at block 538, if the last flag is set to the “off” state, e.g., indicating that a frame has been received from host 202 before the TBTT has expired, then the method may include starting to transmit the preamble and/or protection frames related to the first frame. As indicated at block 562, the method may include proceeding to transmit the first frame as part of a burst, as described below.

As indicated at block 542, the method may include waiting for the predetermined wait-for-next-frame time period, e.g., as described above. For example, the method may include activating timer 254 to count down from the SIFS time, and waiting for data to be delivered from host 202, e.g., until SIFS timer 254 reaches the predetermined time for preparing a frame for transmission.

As indicated at block 544, the method may include determining whether the burst-related sub-commands, e.g., of portion 306, of the second Tx command have been received from host 202, e.g., by Tx queue 224.

As indicated at block 546, if the burst-related sub-commands of the second TX command have been received from host 202, then the method may include fetching the second Tx command, e.g., from Tx queue 224.

As indicated at block 550, the method may include determining whether the second frame is suitable for inclusion in the burst, e.g., as described above.

As indicated at block 552, if the second frame is determined to be suitable for bursting, then the method may include determining whether there is sufficient time remaining in the TxOp, e.g., by checking MOT timer 252, for transmitting the second frame.

As indicated at block 554, if the time remaining in the TxOp is determined to be sufficient to transmit the second frame, then the method may include checking the state of the last flag, e.g., checking whether the last flag is at an “on” state or an “off” state”.

As indicated at block 547, if by after waiting the predetermined wait-for-next-frame time period, an insufficient amount of data has been transmitted to the MAC, if the second frame is determined to be not suitable for bursting, if the time remaining in the TxOp is determined to be not sufficient to transmit the second frame, or if the last flag is set at the “on” state, then the method may include informing the host, e.g., host 202, that the first frame has been successfully transmitted and/or that the first frame may not be transmitted during the current burst. For example, controller 232 may be able to produce signal 240 including a response value indicative of a successful transmission of the first frame and/or that the first frame may not be transmitted during the current burst. The method may also include ending the burst transmission mode, as indicated at block 548.

As indicated at block 556, if the last flag is at the “off” state, e.g., indicating that there may be enough time left in the TBTT for transmitting the second frame in the burst, then the method may include waiting for expiration of the SIFS following the first frame or a prior received ACK signal, e.g., as timed by SIFS timer 254.

As indicated at block 558, the method may include, e.g., after the SIFS time expires, starting to transmit the preamble of the second frame or of a protection frame related to the second frame.

As indicated at block 560, the method may include providing a response to host 202, e.g., using signals 240, indicating that the first frame was either successfully transmitted and received or unsuccessfully transmitted. According to some exemplary embodiments of the invention, providing the response may be performed while PHY 220 is transmitting the preamble.

As indicated at block 564, the method may include determining whether the transmission time of the second frame is expected to be longer than the time remaining until expiration of the TBTT. If the transmission expected time of the second frame is determined to be longer than the time remaining until expiration of the TBTT, then the method may include setting the last-flag to the “on” state, e.g., as described above.

As indicated at block 566, the method may include preparing the second frame for transmission. Alternatively or additionally, the method may include receiving one or more protection signals, e.g., CTS signals, for example, if protection of the second frame is required. Thus, it should be noted that the loading, inclusion and/or transmission of at least some data of the second frame, e.g. which was provided by Tx queue 224, may be performed after transmission of the preamble related to the second frame has begun, e.g., as described above with reference to FIG. 4.

As indicated at block 568, the method may include waiting for the end of the transmission of the second frame.

As indicated at block 570, the method may include determining, e.g., after the second frame has been transmitted, whether an ACK signal is expected for the second frame. If no ACK signal is expected, then the method may continue at block 540 to evaluate or determine whether a next frame is suitable for transmission in the burst.

As indicated at block 572, if an ACK signal is expected then the method may include determining whether an ACK signal was received in a timely manner, such as for example at the end of the SIFS of the second frame's transmission. If the ACK signal was received, then the method may continue at block 540 to determine whether a next frame may be transmitted in the burst. If no ACK signal was timely received, then the method may in some embodiments continue at block 522, wherein an attempt may be made to retry transmitting the second frame within the burst.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

1. A method comprising:
performing during a first time period of a burst mode at least one transmission-related operation corresponding either to a previous data frame or to transmission of a current data frame during a second time period of said burst mode, wherein said first time period at least partially overlaps said second time period.

2. The method of claim 1, wherein said current data frame and said previous data frame correspond to two previously received transmit commands, respectively.

3. The method of claim 1, wherein performing said at least one transmission-related operation comprises preparing for transmission a data portion of said current data frame.

4. The method of claim 3, wherein preparing for transmission said data portion comprises processing one or more sub-commands of a transmit command corresponding to said current data frame.

5. The method of claim 1, wherein performing said at least one transmission-related operation comprises providing to a host a response related to said previous data frame.

6. The method of claim 1, wherein performing said at least one transmission-related operation comprises providing to a host a response related to said previous data frame during a third time period, and preparing for transmission a data portion of said current data frame during a fourth time period succeeding said third time period.

7. The method of claim 1, comprising transmitting a preamble of said current data frame during a third time period within said second time period, wherein said first time period at least partially overlaps said third time period.

8. A method comprising:
determining whether a current data frame is to be transmitted during a burst time period based on one or more burst-related sub-commands of a transmit command corresponding to said current data frame.

9. The method of claim 8, wherein said one or more burst-related sub-commands comprise at least one of a sub-command related to a quality-of-service, a priority sub-command and a sub-command related to an expected transmission time of said data frame.

10. The method of claim 8 comprising receiving an indication of said one or more burst-related sub-commands before receiving a data portion of said current data frame.

11. The method of claim 8 comprising receiving a response related to a previous data frame before determining whether said current data frame is to be transmitted during said burst time period.

12. The method of claim 8, wherein determining whether said current data frame is to be transmitted during said burst time period comprises determining whether said current data frame is suitable for transmission as part of a burst transmission according to a predefined protocol.

13. The method of claim 8, wherein determining whether said current data frame is to be transmitted during said burst time period comprises determining whether at least part of said current data frame is expected to be transmitted during a target beacon transmission time period.

14. The method of claim 13 comprising transmitting said current data frame during said burst time period if part of said current data frame is expected to be transmitted after said target beacon transmission time period has elapsed.

15. The method of claim 13 comprising indicating that a subsequent data frame is not to be transmitted during said burst time period if at least part of said current data frame is expected to be transmitted after said target beacon transmission time period has elapsed.

16. The method of claim 8, wherein determining whether said current data frame is to be transmitted during said burst time period comprises determining whether said current data frame is expected to be transmitted during a transmission opportunity time period.

17. The method of claim 8 comprising:
waiting a predetermined first time period before determining whether or not said current data frame is to be transmitted during said burst time period; and
preparing said data frame for transmission during a second time period,
wherein the sum of said first time period and said second time period is substantially equal to a predetermined inter frame space time period.

18. The method of claim 17, wherein said inter frame space time period comprises a short inter frame space time period.

19. The method of claim 17, wherein said inter frame space time period comprises a point inter frame space time period.

20. The method of claim 8 comprising generating said transmit command, wherein bits of said transmit command representing said one or more burst-related sub-commands are preceded by no more than a non-significant number of bits representing other sub-commands of said transmit command excluding operation codes.

21. An apparatus comprising:
a controller able to perform during a first time period of a burst mode at least one transmission-related operation corresponding either to a previous data frame or to transmission of a current data frame during a second time period of said burst mode, wherein said first time period at least partially overlaps said second time period.

22. The apparatus of claim 21, wherein said current data frame and said previous data frame correspond to two previously received transmit commands, respectively.

23. The apparatus of claim 21, wherein said controller is able to prepare for transmission a data portion of said current data frame during said first time period.

24. The apparatus of claim 21, wherein said controller is able to provide to a host a response related to said previous data frame during said first time period.

25. The apparatus of claim 21, wherein said controller is able to provide to a host a response related to said previous data frame during a third time period, and to prepare for transmission a data portion of said current data frame during a fourth time period succeeding said third time period.

26. An apparatus comprising:
a controller able to determine whether a current data frame is to be transmitted during a burst time period based on one or more burst-related sub-commands of a transmit command corresponding to said current data frame.

27. The apparatus of claim 26, wherein said one or more burst-related sub-commands comprise at least one of a quality-of-service sub-command, a priority sub-command and a sub-command related to an expected transmission time of said data frame.

28. The apparatus of claim 26, wherein said controller is able to determine whether said current data frame is suitable for transmission as part of a burst transmission according to a predefined protocol.

29. The apparatus of claim 26, wherein said controller is able to determine whether at least part of said current data frame is expected to be transmitted during a target beacon transmission time period.

30. The apparatus of claim 29, wherein said apparatus is able to transmit said current data frame during said burst time period if part of said current data frame is expected to be transmitted after said target beacon transmission time period has elapsed.

31. The apparatus of claim 29, wherein said controller is able to exclude from said burst time period a transmission of a subsequent data frame if at least part of said current data frame is expected to be transmitted after said target beacon transmission time period has elapsed.

32. The apparatus of claim 26, wherein said controller is able to determine whether said current data frame is expected to be transmitted during a transmission opportunity time period.

33. The apparatus of claim 26, wherein said controller is able to wait a predetermined first time period before determining whether or not said current data frame is to be transmitted during said burst time period, and to prepare said data frame for transmission during a second time period, and wherein the sum of said first time period and said second time period is substantially equal to a predetermined inter frame space time period.

34. The apparatus of claim 33, wherein said inter frame space time period comprises a short inter frame space time period.

35. The apparatus of claim 33, wherein said inter frame space time period comprises a point inter frame space time period.

36. The apparatus of claim 26, wherein bits of said transmit command representing said one or more burst-related sub-commands are preceded by no more than a non-significant number of bits representing other sub-commands of said transmit command excluding operation codes.

37. A system comprising:
a communication device comprising:
a controller able to perform during a first time period of a burst mode at least one transmission-related operation corresponding either to a previous data frame or to a current data frame; and
one or more antennas able to transmit said current data frame during a second time period of said burst mode, wherein said first time period at least partially overlaps said second time period.

38. The system of claim 37, wherein said controller is able to prepare for transmission a data portion of said current data frame during said first time period.

39. The system of claim 37, wherein said controller is able to provide to a host a response related to said previous data frame during said first time period.

40. A system comprising:
a communication device comprising:
a controller able to determine whether a current data frame is to be transmitted during a burst time period based on one or more burst-related sub-commands of a transmit command corresponding to said current data frame; and
one or more antennas able to transmit said current data frame.

41. The system of claim 40, wherein said controller is able to determine whether at least part of said current data frame is expected to be transmitted during a target beacon transmission time period.

42. The system of claim 40, wherein said controller is able to wait a predetermined first time period before determining whether or not said current data frame is to be transmitted during said burst time period, and to prepare said data frame for transmission during a second time period, and wherein the sum of said first time period and said second time period is substantially equal to a predetermined inter frame space time period.

43. A program storage device having instructions readable by a machine that when executed by the machine result in:
performing during a first time period of a burst mode at least one transmission-related operation corresponding either to a previous data frame or to transmission of a current data frame during a second time period of said burst mode, wherein said first time period at least partially overlaps said second time period.

44. The program storage device of claim 43, wherein the instructions resulting in performing said at least one transmission-related operation result in preparing for transmission a data portion of said current data frame.

45. The program storage device of claim 43, wherein the instructions resulting in performing said at least one transmission-related operation result in providing to a host a response related to said previous data frame.

46. A program storage device having instructions readable by a machine that when executed by the machine result in:
determining whether a current data frame is to be transmitted during a burst time period based on one or more burst-related sub-commands of a transmit command corresponding to said current data frame.

47. The program storage device of claim 46, wherein the instructions resulting in determining whether said current data frame is to be transmitted during said burst time period result in determining whether at least part of said current data frame is expected to be transmitted during a target beacon transmission time period.

48. The program storage device of claim 46, wherein said instructions result in:
waiting a predetermined first time period before determining whether or not said current data frame is to be transmitted during said burst time period; and
preparing said data frame for transmission during a second time period, wherein the sum of said first time period and said second time period

49. The system of claim 37 comprising another communication device able to receive one or more data frames transmitted by said one or more antennas.

50. The system of claim 40 comprising another communication device able to receive one or more data frames transmitted by said one or more antennas.
